(19) United States
(12) Patent Application Publication
(10) Pub. No.: US 2011/0222385 A1
(43) Pub. Date: Sep. 15, 2011

(54) APPARATUS AND METHOD FOR TESTING SPOKE SENSOR

(75) Inventors: Chun-Wen LAI, Taoyuan County (TW); Chi-Hsiang Kuo, Taoyuan County (TW); Shih-Jung Huang, Taoyuan County (TW)

(73) Assignee: QUANTA STORAGE INC., Taoyuan County (TW)

(21) Appl. No.: 12/980,286

(22) Filed: Dec. 28, 2010

(30) Foreign Application Priority Data
Mar. 10, 2010 (TW) 099107042

(51) Int. Cl. G11B 27/36

(52) U.S. Cl. 369/53.11; G9B/27.052

(57) ABSTRACT

An apparatus and a method for testing spoke sensor are disclosed. A drive unit is started to rotate a test disc to a predetermined rotation speed. A module test unit is electrically connected to a spoke sensor under test of a spindle motor module. The module test unit is started to drive the spoke sensor to detect the spoke signals of the test disc and record the number of detected spoke signals. Within a test time, a comparison unit is used for comparing the number of spoke signals with a threshold, and only when the detected number is larger than a threshold will the spoke sensor be assembled to the product. Thus, the product quality is assured.

This application claims the benefit of Taiwan application Serial No. 99107042, filed Mar. 10, 2010, the subject matter of which is incorporated herein by reference.

### BACKGROUND OF THE DISCLOSURE

1. Field of the Disclosure

The disclosure relates in general to an apparatus and a method for testing a spoke sensor, and more particularly to an apparatus and a method for testing a spoke sensor which detects label-side spoke signals before the assembly of a light scribe disk drive.

2. Description of the Related Art

Apart from reading the data side of an optical disc with the laser light emitted by the optical pick-up head, the light scribe disk drive can further write the user's favorite pattern or text on the label side of the optical disc with the laser light emitted by the optical pick-up head to mark the content stored in the optical disc.

As indicated in FIG. 1, a testing structure of a light scribe disk drive 10 according to related art is shown. The light scribe disk drive 10 includes a traverse 11. A spindle motor module 12 is disposed at one terminal of the traverse 11 near the center of the light scribe disk drive 10. The spindle motor module 12 has a spindle motor 13 for rotating an optical disc 14. An optical pick-up head 15 is disposed at the other terminal of the traverse 11. The optical pick-up head 15 projects a laser light to the optical disc 14, and moves reciprocally along the radial direction of the optical disc 14 to read/write the data side of the optical disc 14.

Since the label side of the optical disc 14 is lack of data track serving as a positioning reference for the optical pick-up head 15, a spoke ring 16 formed by about 400 radiating spokes is disposed within a particular radius on the inner rings of the label side of the optical disc 14 to comply with the specification of light scribe disc. In other words, one ring of the optical disc 14 is divided into 400 azimuth angles each being 360/400 degrees. The 400 azimuth angles serve as angle position by which the optical pick-up head 15 writes pattern or text on the label side. For the optical pick-up head 15 to obtain an angle position on the label side of the optical disc 14, a spoke sensor 17 is disposed at a position opposite to the spoke ring 16 (in other words, the spoke sensor 17 is disposed on the spindle motor module 12) for projecting a light beam to the spokes of the spoke ring 16 and receive the light reflected from the spokes and further transmits the reflected light signals to the light scribe disk drive 10. The position of the optical pick-up head 15 is determined according to the reflected light signals and the moving distance of the optical pick-up head 15 in the radial direction.

To check whether the light scribe disk drive 10 functions normally or not after assembly, the connection interface 18 of the light scribe disk drive 10 is connected to a testing apparatus 19. The testing apparatus 19 provides a test signal, which controls the light scribe disk drive 10 to read/write the data side of the optical disc 14. And whether the light scribe disk drive 10 passes test or not is determined according to the comparison of the actually transmitted read/write signals and the writing of pattern on the label side to assure the product quality.

Since the spoke sensor 17 is an important element of the light scribe disk drive 10, the quality of the spoke sensor 17 is crucial to the accuracy of writing pattern on the label side by the light scribe disk drive 10. Once defects occur to the circuit soldering or the elements of the spoke sensor 17, the light scribe disk drive 10 will be unable to write pattern on the label side normally or will end up with poor quality in writing pattern on the label side. The light scribe disk drive 10 may be classified as defective products and needs to be disassembled, checked, adjusted, replaced or even discarded and incurs more manufacturing cost due to the spoke sensor 17 being defective. Thus, the light scribe disk drive still has many problems to resolve when it comes to the testing apparatus and method.

### SUMMARY OF THE DISCLOSURE

According to a first aspect of the present disclosure, an apparatus and a method for testing a spoke sensor are provided. Prior to the assembly of a light scribe disk drive, whether the spoke sensor of a spindle motor module can detect spoke signals is tested first to assure the product quality.

According to a second aspect of the present disclosure, an apparatus and method for testing a spoke sensor are provided. An independent drive unit drives a test disc to rotate at a predetermined rotation velocity continuously. Since there is no need to shut down the drive unit or adjust the rotation speed of the test disc during the replacement of a device under test, the test time is shortened.

According to a third aspect of the present disclosure, a spoke sensor testing method is provided. Within a fixed test time, the determination regarding whether the spoke sensor is normal is based on whether the number of detected spoke signals is larger than a threshold, so as to increase the accuracy of testing.

To achieve the above aspects of the present disclosure, the spoke sensor testing apparatus of the disclosure controls a drive unit with a control unit to rotate a test disc clamped by a rotation motor at a predetermined speed. The control unit further controls an independent module test unit, which clamps and electrically connects a spindle motor module via a test machine, so that the spoke sensor disposed on the spindle motor module detects and displays the spoke signals of the test disc on a display device. The detected spoke signals are further transmitted to a comparison unit, which compares the number of spoke signals with a threshold to determine the test result.

The spoke sensor testing method of the disclosure includes the following steps: Firstly, a drive unit is started to rotate a test disc to a predetermined rotation speed. Next, a module test unit is electrically connected to a spoke sensor under test of a spindle motor module. Then, the module test unit is started to drive the spoke sensor to detect the spoke signals of a test disc and record the number of detected spoke signals. Within a test time, whether the number of detected spoke signals is larger than a threshold is determined: if yes, the spoke sensor passes the test and is assembled to the product. Wherein, the predetermined speed can be a constant angular velocity, and the test time can be fixed and shorter than the test time for going around the spoke ring of the test disc once.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 shows a testing structure of a light scribe disk drive according to related art.

FIG. 2 shows a functional diagram of a spoke sensor testing apparatus of the disclosure.

FIG. 3 shows a spoke signal diagram detected by a normal spoke sensor.

FIG. 4 shows a spoke signal diagram detected by an abnormal spoke sensor.

FIG. 5 shows a flowchart of a spoke sensor testing method according to a first embodiment of the disclosure.

FIG. 6 shows the spoke signals not detected by a spoke sensor.

FIG. 7 shows a flowchart of a spoke sensor testing method according to a second embodiment of the disclosure.

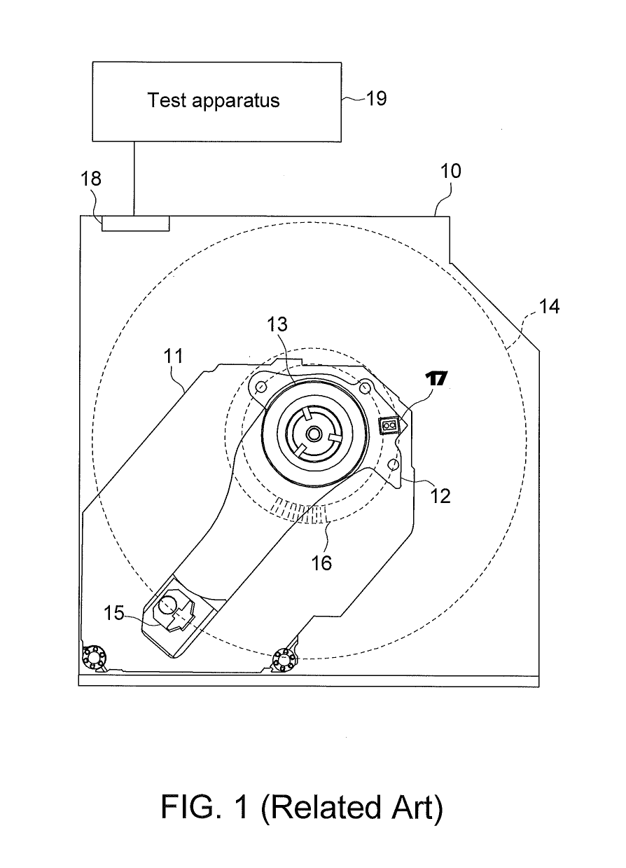

### DETAILED DESCRIPTION OF THE DISCLOSURE

The details and effects of the technologies adopted in the disclosure to achieve the above aspects are disclosed in a number of preferred embodiments below with accompanying drawings.

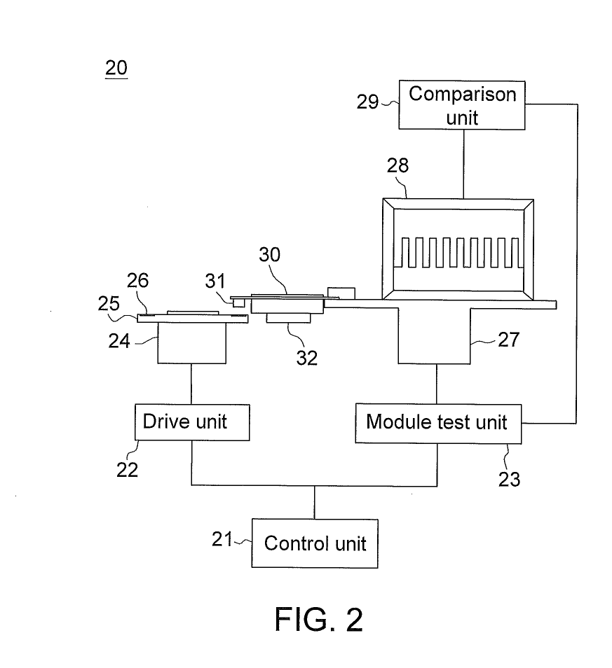

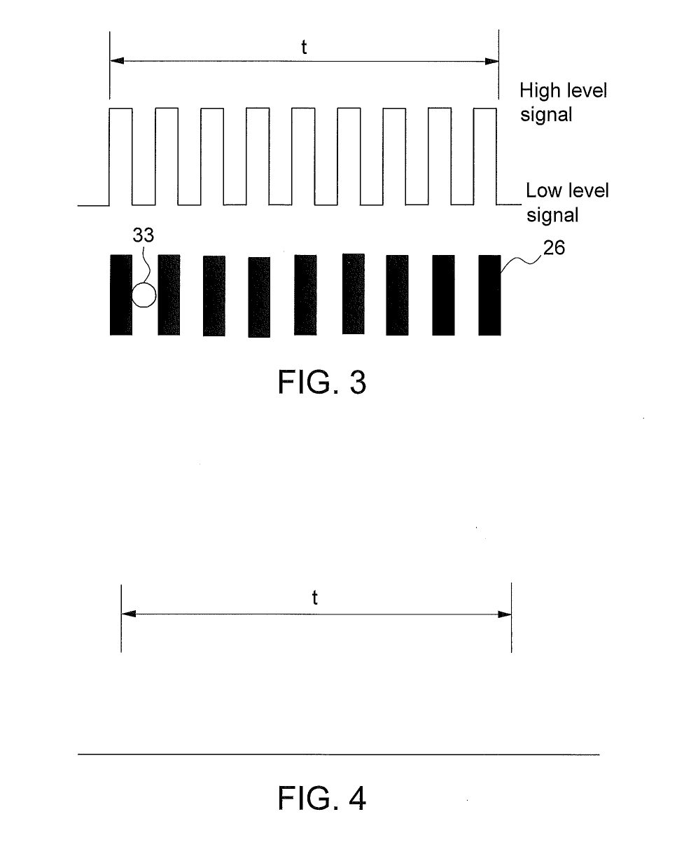

Referring to FIG. 2, FIG. 3 and FIG. 4. FIG. 2 shows a functional diagram of a spoke sensor testing apparatus of the disclosure. FIG. 3 shows a spoke signal diagram detected by a normal spoke sensor. FIG. 4 shows a spoke signal diagram detected by an abnormal spoke sensor. The testing apparatus 20 of FIG. 2 is used for testing the spoke sensor of a light scribe disk drive, and mainly includes a control unit 21, a drive unit 22 and a module test unit 23. The drive unit 22 and the module test unit 23 are two mutually independent units both controlled by the control unit 21.

The drive unit 22 is controlled by the control unit 21 to rotate a test disc 25 clamped by the rotation motor 24 at a predetermined speed. The test disc 25 has a spoke ring 26 which is conformed to the specification of a light scribe disc. The predetermined speed at which the drive unit 22 rotates the rotation motor 24 is preferably set as the rotation speed at which the light scribe disk drive reads the coding of the light scribe disc, and normally is set as a constant angular velocity (CAV). After rotating the rotation motor 24, the drive unit 22 is not affected by the start or pause during the testing process of the module test unit 23, and continues to rotate the rotation motor 24 at a predetermined speed so that the test disc 25 is rotated at a constant rotation speed.

The module test unit 23 is controlled by the control unit 21, and is connected to a display device 28 disposed on a test machine 27 via the test machine 27. The display device 28 can be realized by a screen or an oscilloscope for displaying the detected spoke signals and transmitting the spoke signals to a comparison unit 29. The module test unit 23 controls the comparison unit 29 to compare the spoke signals so as to determine the test result which can be displayed on the display device 28. The test machine 27 clamps and electrically connects an under-test spindle motor module 30, so that the spoke sensor 31 disposed on the spindle motor module 30 is located above the rotation path of the spoke ring 26 disposed on the test disc 25 and opposite and close to the spoke ring 26 for the convenience of detecting the spoke signals.

The spindle motor module 30 not yet assemble to a light scribe disk drive is tested according to the following procedures. Firstly, the testing apparatus 20 is activated, and the control unit 21 immediately starts the drive unit 22, which rotates the test disc 25 disposed on the rotation motor 24 at a predetermined rotation speed, and the predetermined rotation speed is maintained. Next, the under-test spindle motor module 30 is clamped by and electrically connected to the test machine 27. The control unit 21 starts the module test unit 23, which further starts the display device 28 and enables the spindle motor module 30 via the test machine 27. The started spoke sensor 31 projects a light beam to the spoke ring 26, receives a reflected light from the spokes, displays a light signal on the display device 28, and transmits the light signal to the comparison unit 29. The comparison unit 29 compares the spoke signal to determine a test result which is further displayed on the display device 28. To simplify the testing process and save energy, when the module test unit 23 is started to enable the spindle motor module 30, the spindle motor 32 does not rotate.

Referring to FIG. 3. During the testing process, the light beam 33 projected by the spoke sensor 31 passes through the spokes of the spoke ring 26. Since the light reflected from the spokes is stronger, the detected light signal is at high level. Since the light reflected from the label side at the interval between the spokes is very weak, the detected light signal is at low level. After test time t, that is, the time to go around the spoke ring 26 once, the light signals detected by the spoke sensor 31 which functions normally form the spoke signals with high level signals alternating with low signals, wherein the number of spoke signals is larger than 0. Referring to FIG. 4. To the contrary, after test time t, the light signals detected by the spoke sensor 31 which cannot operate normally almost form a straight line, the spoke signals with high level signals alternating with low signals cannot be obtained, and the number of spoke signals is 0. The testing apparatus 20 determines whether the spoke sensor 31 passes the test or not according to whether the spoke signals are detected, and defective products are thus screened out.

Referring to FIG. 2, when the test of a spindle motor module 30, the control unit 21 shuts down the module test unit 23, but the drive unit 22 is not affected by the shutting of the module test unit 23 and continues to rotate the rotation motor 24 at a predetermined speed. Next, the spindle motor module 30 is dismounted and another under-test is placed. Then, the control unit 21 starts the module test unit 23. Since the drive unit 22 continues to rotate the rotation motor 24 at the predetermined speed, the test can be continued in a non-stop manner without having to wait for the test disc 25 to reach the predetermined rotation speed. Thus, the test time can be shortened.

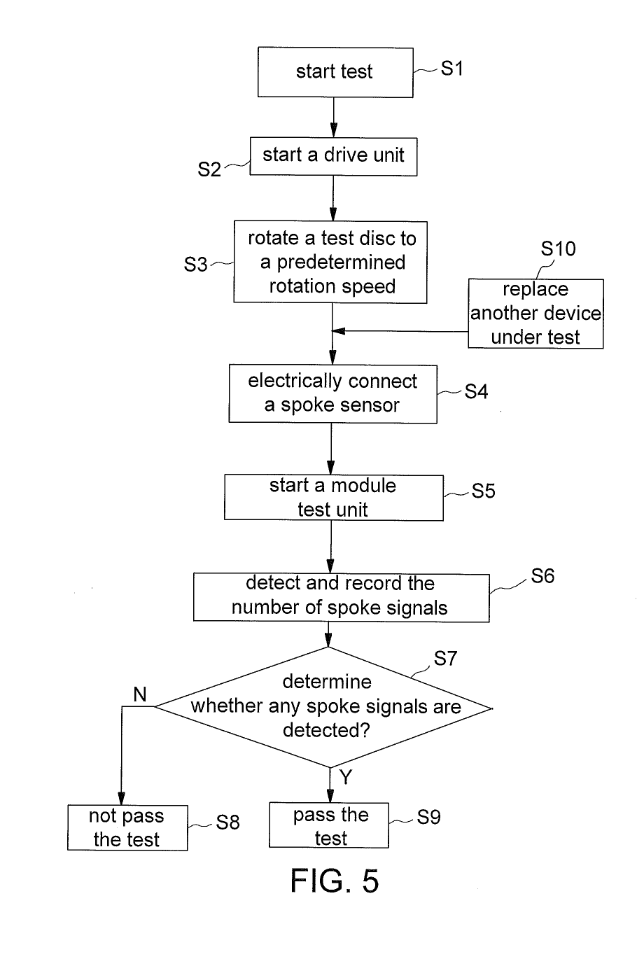

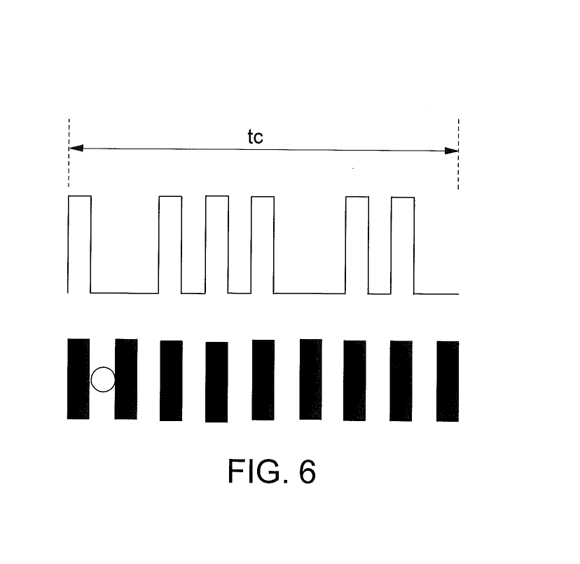

As indicated in FIG. 5, a flowchart of a spoke sensor testing method according to a first embodiment of the disclosure is shown. The test of screening out defective spoke sensors is based on whether the spoke signals are detected normally. The detailed procedures of testing the spoke sensor are disclosed below: Firstly, the method begins at step S1, a testing apparatus is started to test the spoke sensor. In step S2, a drive unit is started. Then, the method proceeds to step S3, the drive unit rotates the test disc to a predetermined rotation speed, and maintains the predetermined rotation speed. After that, the method proceeds to step S4, the module test unit is electrically connected to the spoke sensor of an under-test spindle motor module. In step S5, a module test unit is started. In step S6, the spoke sensor is driven to detect the spoke signals of a test disc and record the number of detected spoke signals. Then, the method proceeds to step S7, within the test time whether there are spoke signals being detected is determined. If the number of detected spoke signals is equal to 0, then it is concluded that no spoke signal is detected, and the method proceeds to step S8, the spoke sensor is classified as a defective product which does not pass the test. If there is spoke signal being detected, then it is concluded that the number of detected spoke signals is larger than 0, and the method proceeds to step S9, the spoke sensor is classified as a good-quality product which passes the test. After the test is completed, if another device under test needs to be tested, then the method proceeds to step S10. In step 10, the module test unit is shut down, another device under test of the spindle motor module is placed without affecting the drive unit, and the method proceeds to step S4 to continue the testing process.

Thus, according to the spoke sensor testing method of the disclosure, prior to the assembly of the light scribe disk drive, the spoke sensor of the spindle motor module is tested, and whether the spoke sensor is a good-quality product is determined according to whether normal spoke signals are detected so as to assure the manufacturing quality of the light scribe disk drive.

As indicated in FIG. 6, the spoke signals not detected by a spoke sensor are shown. The spoke sensor with poor manufacturing quality or unstable operating state will miss some spokes. If only a small amount of spoke signals are missed, the impact on the writing of pattern on the label side is minor, but the writing of pattern will be severely distorted if a large amount of spoke signals are missed. Thus, the test on the detected still needs to further screening out defective products to assure the product quality. According to the spoke sensor testing method of the second embodiment of the disclosure, a fixed test time tc is adopted, the number of detected spoke signals is calculated and compared to a predetermined threshold denoting an acceptable number of spoke signals. If the number of spoke signals detected by the spoke sensor under test is smaller than the threshold, then the spoke sensor under test is screened out to assure the accuracy of the test. The spoke sensor which functions normally will be able to detect the spoke signals with any segment of the spoke ring. Thus, in the second embodiment of the disclosure, the fixed test time tc can be shorter than the test time t (the time for going around the spoke ring once), to shorten the test time and increase the testing efficiency. For example, the fixed test time tc is set as ⅓ or half of the test time t.

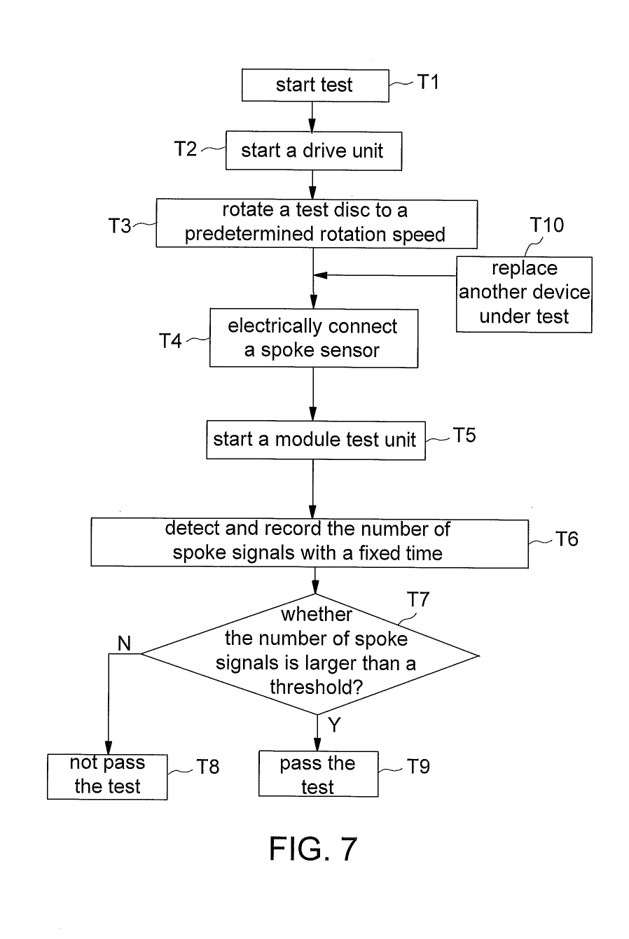

As indicated in FIG. 7, a flowchart of a spoke sensor testing method according to a second embodiment of the disclosure is shown. According to the second embodiment of the disclosure, a threshold denoting an acceptable number of spoke signals is predetermined to screen out defective spoke sensors. The detailed procedures are disclosed below: Firstly, the method begins at step T1, a testing apparatus is started to test a spoke sensor. In step T2, a drive unit is started. Then, the method proceeds to step T3, the drive unit rotates the test disc to a predetermined rotation speed, and maintains the predetermined rotation speed. After that, the method proceeds to step T4, the module test unit clamps and electrically connected to a spoke sensor under test of a spindle motor module. In step T5, a module test unit is started. In step T6, within a predetermined test time, the spoke sensor is driven to detect the spoke signals of a test disc and record the number of detected spoke signals. Then, the method proceeds to step T7, whether the number of spoke signals is larger than the threshold is determined. If the number of detected spoke signals is not larger than the threshold, then the method proceeds to step T8, the spoke sensor is classified as a defective product which does not pass the test. If the number of detected spoke signals is larger than the threshold, then the method proceeds to step T9, the spoke sensor is classified as a good-quality product which passes the test. After the test is completed, if another device under test needs to be tested, then the method proceeds to step T10 to shut down the module test unit, and another device under test of the spindle motor module is placed without affecting the drive unit, and the method proceeds to step T4 to continue the testing process.

According to the spoke sensor testing method of the second embodiment of the disclosure, the determination regarding whether the spoke sensor is normal is based on whether the number of detected spoke signals within a shorter test time is larger than a threshold denoting an acceptable number of spoke signals. Since the method does not need to read all spokes of the spoke ring, both the testing efficiency and accuracy are increased.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A spoke sensor testing apparatus for testing a spoke sensor of a light scribe disk drive, the testing apparatus comprising:
a control unit;
a drive unit controlled by the control unit for rotating a test disc clamped by a rotation motor at a predetermined speed, wherein the test disc has a spoke ring;
a module test unit, wherein the drive unit and the module test unit are two mutually independent units both controlled by the control unit, the module test unit clamps and electrically connects a spindle motor module via a test machine, so that the spoke sensor disposed on the spindle motor module is located above a rotation path of the spoke ring to detect spoke signals, and the detected spoke signals are displayed on a display device disposed on the test machine, and are transmitted to a comparison unit, which compares the number of spoke signals with a threshold to determine a test result.

2. The spoke sensor testing apparatus according to claim 1, wherein after rotating the rotation motor, the drive unit is not affected by the testing process of the module test unit, and continues to rotate the rotation motor at a predetermined speed.

3. The spoke sensor testing apparatus according to claim 1, wherein when the module test unit is tested, the spindle motor of the spindle motor module does not rotate.

4. A spoke sensor testing method, comprising:
(1) starting a drive unit to rotate a test disc to a predetermined rotation speed;
(2) electrically connecting a module test unit to a spoke sensor under test of a spindle motor module;
(3) starting the module test unit to drive the spoke sensor to detect the spoke signals of the test disc and record the number of detected spoke signals; and
(4) within a test time, determining whether the number of detected spoke signals is larger than a threshold: if the number of detected spoke signals is not larger than the threshold, then the spoke sensor is determined as not passing the test; if the number of detected spoke signals is larger than the threshold, then the spoke sensor is determined as passing the test.

5. The spoke sensor testing method according to claim 4, wherein the predetermined speed is a constant angular velocity.

6. The spoke sensor testing method according to claim 4, wherein the threshold of step (4) is 0.

7. The spoke sensor testing method according to claim 4, wherein the test time is a time for going around the spoke ring of the test disc once.

8. The spoke sensor testing method according to claim 4, wherein the test time is fixed.

9. The spoke sensor testing method according to claim 8, wherein the test time is shorter than a time for going around the spoke ring of the test disc once.

10. The spoke sensor testing method according to claim 4, wherein after the test in the step (4) is completed, if another device under test needs to be tested, then the module test unit is shut down, and another device under test is replaced, and the method returns to step (2) to continue the testing process.
